(19) United States
(12) Patent Application Publication
(10) Pub. No.: US 2019/0358118 A1
(43) Pub. Date: Nov. 28, 2019

(54) SELF-MASSAGING DEVICE FOR ARMS OR LEGS

(71) Applicant: PAOLA BIANCA AGNES VON SYDOW 00142146790, São Paulo (BR)

(72) Inventor: Paola Bianca Agnes VON SYDOW, São Paulo (BR)

(21) Appl. No.: 16/472,668

(22) PCT Filed: Dec. 8, 2017
(86) PCT No.: PCT/BR2017/050373

§ 371 Date: Jul. 12, 2019

(30) Foreign Application Priority Data
Dec. 23, 2016 (BR) 10 2016 030448 2

(51) Int. Cl. A61H 15/00

(52) U.S. Cl. CPC A61H 15/0092; A61H 2015/005; A61H 2201/169; A61H 2201/1253; A61H 2201/1635; A61H 2015/0057

(57) ABSTRACT

A device for self-massage of the arm or leg and, that stimulates the circulation of the massaged member, improves the irregularities of the skin, strengthens the musculature of the massaging member, and allows the user to exercise one part of the body while massaging another part of the body. The self-massage device comprising a plurality of elastic straps attached to a central cord, each strap comprising a plurality of massage elements; and a handle part connected to the central cord and configured to enable the central cord to move in an upstream and downstream trajectory along the user's arm or leg.

### FIELD OF THE INVENTION

The present invention concerns a device for self-massage of the arm or leg and, more specifically, a self-massage device that stimulates the circulation of the massaged member, improves irregularities of the skin, strengthens the musculature of the member that it massages, and allows the user to exercise one part of the body while massaging the other part of the body.

### GROUNDS OF THE INVENTION

The benefits of massage are widely known. Massage enhances blood and lymph circulation, improving the flow of nutrients and helping to eliminate toxins, and it also assists in muscle relaxation and skin renewal.

Different apparatus and devices for massaging body members are known to the state of the art. These devices may comprise anything from simple manual implements to complex electromechanical and electronic appliances.

Some known implements and devices allow the user to perform a self-massage. This type of device is advantageous for those people who do not have the time or availability to see a massage therapist, but still desire the benefits of massaging.

Brazilian document MU 6901688 describes a therapeutic massager comprising spheres that slide over axes connected to two wires. The wires have anatomical cables at their ends, and the cables are used to move the therapeutic massager over the area to be massaged.

Brazilian document MU 6801334 describes a massager comprising a tape and little wheels with small protrusions. The tape penetrates the axes of the wheels and their ends are secured by nodes that receive protectors.

These tape massagers known to the state of the art are functional for self-massage on the surface of some parts of the body, such as the user's back. However, the user encounters difficulties when massaging the elongated and cylindrical members, such as the arms and legs.

Some solutions of the state of the art reveal massagers developed for specific areas of the body.

North American document US 2016/0296415, for example, describes a massage device for parts of the body subject to repetitive strain injury, which comprises a structure with a base and two arms. Massage elements are mounted on the arms of the device and the body part can be placed between the two arms of the massager to perform the massage.

Although this document describes a solution that enables massaging on a trajectory along the arm or leg, the construction of the device is complex and its structure occupies a large area.

The Chinese document CN 202236260 describes a massager for specific points of the arm comprising an elliptical ring where magnetic bodies are mounted. The user can use the massager on its wrist, like a bracelet.

The massager of this document has a simple construction, but little flexibility in relation to the positioning of the massager bodies.

Brazilian document MU 6801419-8 reveals a device for abdominal self-massage and muscle-building comprising a semicircular cylindrical arch containing adjustable concentric spheres, articulated grips and shock absorbers or pressure regulators for the two larger spheres. The device is configured to fit the user's waist, allowing for massage of the abdominal region.

This Brazilian document describes a useful massage solution for the abdominal region; however, the construction of the device is complex, with several different mechanical elements.

Chinese document CN2282422 describes a massager comprising a ring with elliptical spheres arranged in a rubber band, a ring with circular spheres arranged in a rubber band and a plurality of bands with circular spheres, where the bands extend from the elastic of the ring with elliptical spheres to the elastic of the ring with circular spheres. The massager can be inserted into the wrist or heel of the wearer and the massage is performed by pressing the spheres against the skin in a rotating motion.

The solution presented in this Chinese document reveals a specially constructed massager for the wrist or heel of the user, where the self-massage is performed by pressing the spheres against the skin. However, this massager does not cover the full length of the user's arm or leg and does not allow the pressure to be exerted on a trajectory along the length of the arm or leg.

Although the state of the technique comprises massagers with different constructions, there remains a need for a self-massage device that can be used for self-massage of a user's arm or leg and that allows for the massaging of a trajectory along the entire length of the arm or leg, but at the same time possess simple construction and low cost.

A massager solution is also not known to the state of the art that allows the user to actively exercise one part of the body while massaging another part of the body.

### OBJECTIVES OF THE INVENTION

In order to solve the problems and inconveniences encountered in the solutions of the state of the art, one of the objectives of the present invention is to provide a self-massage device for the arm or leg that is simple and economical in construction.

Another of the objectives of the present invention is to provide a self-massage device for the arm or leg that allows for massaging in a trajectory along the entire length of the arm or leg.

Another objective of the present invention is to provide a self-massage device for the arm or leg that allows the user to actively exercise one part of the body while massaging another part of the body.

Yet another of the objectives of this invention to provide a self-massage device for the arm or leg that is easy and intuitive to use.

### BRIEF DESCRIPTION OF THE INVENTION

The present invention achieves these and other objectives through a self-massage device for the self-massage of a user's arm or leg. The device comprises a plurality of elastic straps attached to a central cord, with each strap comprising a plurality of massage elements, and a handle part attached to the central cord and configured to enable the movement of the central cord upstream and downstream the trajectory of the user's arm or leg.

In the preferred embodiment of the present invention, the handles of the plurality of elastic straps are arranged in substantially parallel planes, and the central cord extends substantially perpendicularly to the parallel planes of the straps.

Preferably, the handle part consists of three extensions of the central cord, where a first extension comprises a first element of the handle, a second extension comprises a second handle element, and a third extension forms a fastener to receive the first and second handle elements.

Still concerning the preferred embodiment of the present invention, the elastic straps, the central cord and the extenders of the handle part are formed from a single elastic cord.

Preferably, the plurality of straps comprises six straps, the massage elements comprise spheres, and each strap of the plurality of straps comprises about fifteen spheres. The handle elements can comprise spheres similar to those used as massage elements.

The spheres can be polymeric spheres of about 2 cm in diameter, with the surface smooth or worked.

### BRIEF DESCRIPTION OF THE DRAWINGS

The present invention will be described below in more detail, with references to the attached drawings, where:

FIG. 1—is a perspective view of the self-massage device according to a preferred embodiment of the present invention;

FIG. 2—is a view illustrating the self-massage device according to the preferred embodiment of the present invention being inserted onto a user's arm;

FIG. 3—is a perspective view of one of the straps of the self-massage device according to the preferred embodiment of the present invention;

FIG. 4—is a view illustrating the self-massage device according to the preferred embodiment of the present invention during its use;

FIG. 5—is a perspective view of the component parts of the handle part of the self-massage device according to the preferred embodiment of the present invention; and

FIG. 6—is a perspective view of the handle part of the self-massage device according to the preferred embodiment of the present invention.

### DETAILED DESCRIPTION OF THE INVENTION

The present invention will be described below based on an example of the preferred embodiment of the self-massage device according to the present invention.

The self-massage device 1 of the present invention comprises a plurality of elastic straps 2. Each of the elastic straps 2 comprises a plurality of massage elements 2a.

In the preferred embodiment of the present invention shown in the drawings, the device 1 comprises six elastic straps and each elastic strap comprises approximately fifteen massage elements (see FIG. 3). Of course, it should be understood that the number of straps and the quantity of massage elements could be different in alternative embodiments of the present invention.

Preferably, the massage elements comprise plastic spheres of around 2 cm in diameter. The spheres can have a smooth or worked surface with bumps, grooves or other irregularities.

It should be emphasized that although the drawings show massaging elements of a spherical shape, different shapes could be used within the concept of the present invention, provided that they allow the element to slide along the arm or leg of the user.

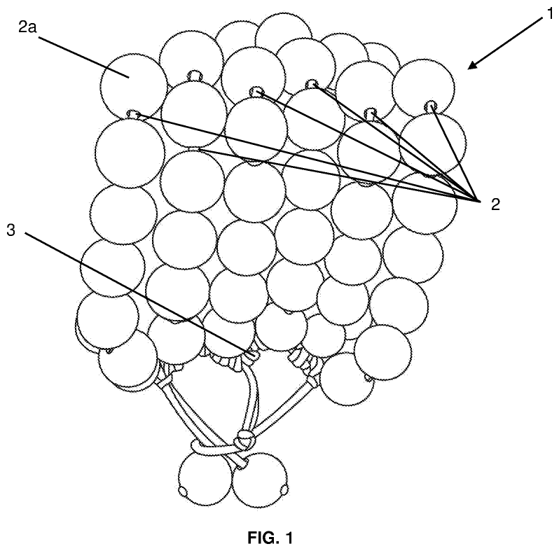

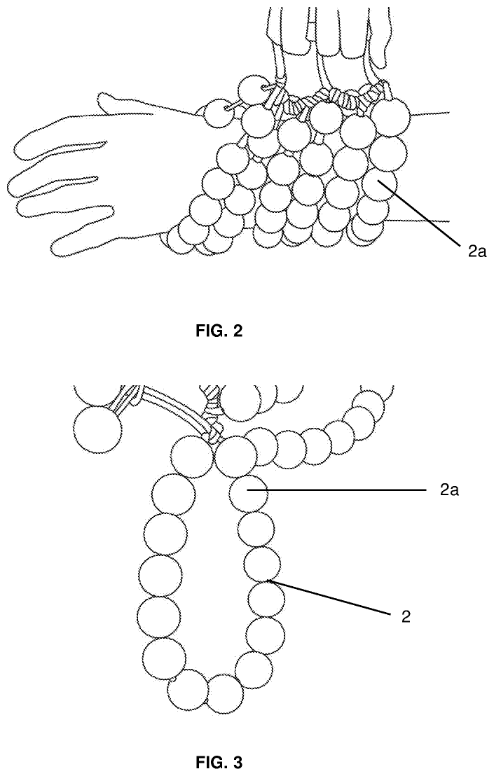

As can be seen in FIG. 1, the straps 2 are arranged in substantially parallel planes and are connected to a central cord 3. In this way, the user can insert its hand through the inner opening of the straps, causing the massaging elements 2a to be arranged circumferentially around the arm.

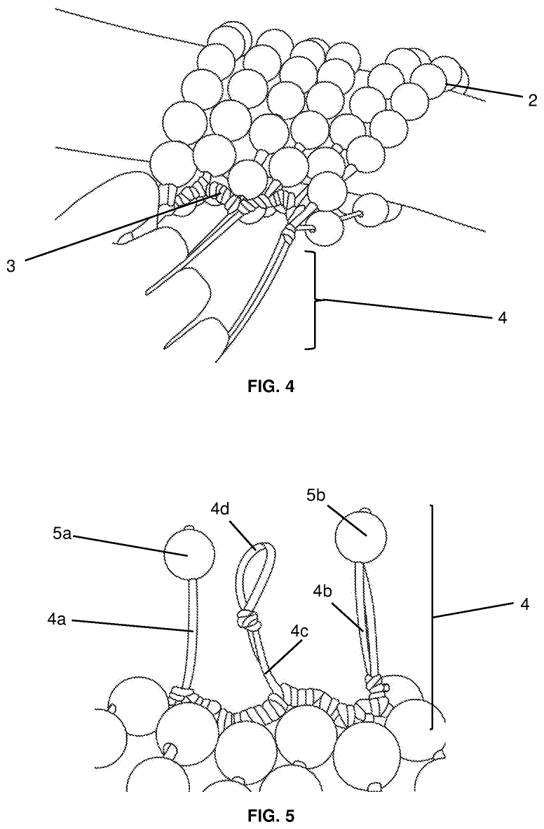

As illustrated in FIG. 4, the central cord 3 is configured so that it extends perpendicularly to the substantially parallel planes of the straps 2. Thus, when the cord is moved upstream and downstream the user's arm or leg, the straps 2 slide along the user's arm or leg, causing the massaging elements not only to press against the skin of the arm or leg, but to massage the length of the arm during the upstream and downstream movement.

The central cord 3 is connected to a handle part 4. This handle part 4 is configured to allow the movement of the central cord 3 in an upstream and downstream trajectory.

In the preferred embodiment of the present invention, the handle part 4 consists of three extensions of the central cord:

a first extension 4a that extends from a first end of the central cord 3 and which comprises a first handle element 5a;

a second extension 4b which extends from a second end of the central cord 3 and which comprises a second handle element 5b; and

a third extension 4c which forms a fastener 4d to receive the first and second handle elements 5a, 5b.

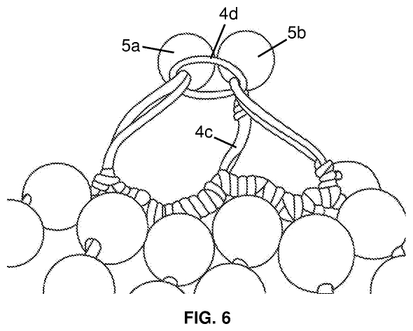

To form the handle part 4, the handle elements 5a, 5b are inserted into the elastic loop (fastener) 4d of the third extension 4c, as shown in FIG. 6.

In the preferred embodiment of the present invention, the handle elements 5a, 5b are spheres similar to the spheres used as massaging elements 2a. However, in alternative embodiments, different handle elements could be used.

In the preferred embodiment of the present invention, the elastic straps 2, the central cord 3 and the extensions 4a, 4b, 4c of the handle part 4 are formed from a single elastic cord.

To form the device, the long elastic cord is folded in half. The folded end is used as one of the extensions 4b of the handle part 4, and the handle element 5b has a through hole that receives the folded end. One end of the through hole is formed wider so that a lock node is formed in the extension 4b and housed at the widest end of the through hole of the handle element 5b.

The elastic straps 2 are alternately formed by the “legs” of the folded elastic cord. Thus, the spheres or massaging elements 2a are pierced with a through hole for the passage of the leg of the elastic cord. The length of each strap is delineated by knots in the elastic cord itself. Preferably, the knots that delineate the straps are made by forming the central cord 3. Which is to say, the knots are formed from the union of the handles 2 and the central cord 3.

The extension 4c of the handle part 4 is formed after the formation of three straps 2, so that the extension 4c extends approximately from the middle of the central cord 3.

The extension 4c is formed by a portion of elastic cord folded with the fastener (elastic loop) 4d being formed from a knot in the portion. The extension 4c also joins the central cord 3 through a knot formation.

The other three straps 2 are formed similarly to the first three straps, and the last strap leaves a leftover elastic cord that will be folded to form the extension 4a whose end knot is received by the handle element 5a. Thus, the handle element 5a has a through hole that receives the end knot of the extension 4a. So, the through hole is formed with a wider end to receive this lock knot.

To use the self-massage device of the present invention to self-massage the arm, the user must follow the procedures below:
Insert the hand of the arm to be massaged into the straps 2 of the device 1, so that the massage spheres 2a are positioned on the circumference of the arm, with the straps 2 being substantially in parallel planes along the arm;
hold the handle part 4 of the self-massage device with the other hand and pull the device vigorously so that the central cord 3 is moved upstream the arm (from the wrist to the arm, passing over the forearm) and then pull the device in the opposite direction so that the central cord 3 is moved downstream the arm (from the arm to the wrist, passing over the forearm);
where the movement of the central cord 3 results in the movement of the straps 2 upstream and downstream the arm, depending on the direction in which the user pulls the handle part 4.

For best results, the movement should be repeated, for example, about 40 times on each arm.

As is clear from the above explanation, the self-massage device of the present invention makes the user actively exercise the arm that is not being massaged, as it is used to vigorously pull the handle part of the self-massage device.

In addition to this, for the movement to be performed as easily as possible, it is clear that the user should position the arm that moves the device 1 perpendicularly to the torso, with the arm folded at an angle of 90°, so that the forearm stays parallel to the torso and perpendicular to the arm being massaged. This position enhances the effect of the exercise.

To use the self-massage device of the present invention for self-massage of the leg, the user should follow the procedures below:
Insert the foot of the leg to be massaged into the straps 2 of the device 1, so that the massage spheres 2a are positioned on the circumference of the leg, and the straps 2 are substantially in parallel planes along the leg;
Hold the handle part 4 of the self-massage device with the hand and pull the device vigorously so that the central cord 3 is moved upstream the leg (from the heel to the knee) and then pull the device in the opposite direction, so that the central cord 3 is moved downstream the leg (from the knee to the heel);
The movement of the central cord 3 results in the movement of the straps 2 upstream and downstream the leg, depending on the direction in which the user pulls the handle part 4.

Having described an example of the preferred embodiment of the present invention, it should be understood that the scope of the present invention encompasses other possible variations of the inventive concept described, being limited only by the contents of the attached claims, which include the possible equivalents.

1. A self-massage device for the arm or leg comprising a plurality of elastic straps attached to a central cord, each strap comprising a plurality of massage elements; a handle part connected to the central cord and configured to enable the movement of the central cord in an upstream and downstream trajectory along the user's arm or leg.

2. The self-massage device according to claim 1, wherein the straps of the plurality of elastic straps are arranged in substantially parallel planes, and the central cord extends substantially perpendicularly to the parallel planes of the straps.

3. The self-massage device according to claim 1, wherein the handle part consists of three extensions of the central cord, where a first extension comprises a first handle element, a second extension comprises a second handle element, and a third extension forms a fastener to receive the first and second handle elements.

4. The self-massage device according to claim 3, wherein the elastic straps, the central cord and the extensions of the handle part are formed from a single elastic cord.

5. Self-massage device according to claim 1, wherein the massage elements comprise spheres.

6. The self-massage device according to claim 5, wherein the plurality of straps comprises six straps, and each strap of the plurality of straps comprises about fifteen spheres.

7. The self-massage device according to claim 3, wherein the handle elements comprise spheres.

8. The self-massage device according to claim 5 wherein the spheres are polymeric spheres of about 2 cm in diameter.

9. The self-massage device according to claim 5 wherein the spheres are spheres with smooth surfaces.

10. The self-massage device according to claim 5 wherein the spheres are spheres with a worked surface.
